(19) United States
(12) Patent Application Publication
(10) Pub. No.: US 2006/0158727 A1
(43) Pub. Date: Jul. 20, 2006

(54) Device and method for locating a room area

(75) Inventor: Thomas Weiser, Vienna (AT)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/560,637

(22) PCT Filed: Jun. 9, 2004
(86) PCT No.: PCT/IB04/50878

§ 371 Date: Dec. 13, 2005

(30) Foreign Application Priority Data
Jun. 16, 2003 (EP) 03101758.5

(51) Int. Cl. G03B 21/56

(52) U.S. Cl. 359/460

(57) ABSTRACT

In a circuit (15) for a locating device (14) for locating a room area (12) from which an optical locating signal (LS) generated and emitted by means of a locating-signal generating stage (13) originates, there is provided firstly a reception stage (17) that is arranged at a distance (R) from the room area (12) to be located and that is designed to receive, optically, the optical locating signal (LS) that can be fed to it from the room area (12), and there is provided secondly a determining stage (26) that, by using the optical locating signal (LS) that is received, is designed to determine and emit an item of room-area locating information (SI) that represents the distance between the receiving stage (26) and the room area (12).

The invention relates to a circuit for locating a room area from which an optical locating signal that can be generated and emitted by means of a locating-signal generating means originates.

The invention further relates to a locating device for locating a room area from which an optical locating signal that can be generated and emitted by means of a locating-signal generating means originates, which locating device includes a circuit as defined above in the first paragraph.

The invention further relates to an audio-signal emitting system, which audio-signal emitting system includes a circuit as defined above in the first paragraph.

The invention further relates to an audio-signal receiving system, which audio-signal receiving system includes a circuit as defined above in the first paragraph.

The invention further relates to a method for locating a room area from which an optical locating signal that can be generated and emitted by means of a locating-signal generating means originates.

A circuit of the kind specified above in the first paragraph, a locating device of the kind specified above in the second paragraph, an audio-signal emitting system of the kind specified above in the third paragraph, and a method of the kind specified above in the fifth paragraph, are known from patent document EP 0 568 716 A1.

The known audio-signal emitting system is implemented in the form of a stereo loudspeaker enclosure that has the known locating device, which latter is implemented in the form of a sensor having the known circuit. The known locating device is arranged to receive, optically, a locating signal formed by infrared light signals from a listening area, i.e. a room area in front of the stereo loudspeaker enclosure. The known locating device is further arranged to locate the listening area from which the locating signal originates, after which a rotation of two tweeters that is correlated with the listening area that has been located takes place in the known audio-signal emitting system to enable an emission of two audio channel-signals to be adjusted to the listening area that has been located.

However, with the known circuit, and the known locating device and the known audio-signal emitting system, there is the problem that the locating of the room area from which the locating signal originates takes place only in directions lying on a range of levels in front of the locating device, which means that the emission of audio channel-signals can be adjusted only to a range of directions that have been determined in the room in front of the stereo loudspeaker enclosure, which range of directions extends from the sensor to a locating-signal generating means by means of which the locating signal was generated, and beyond.

It is an object of the invention to overcome the problems stated above in a circuit of the kind specified above in the first paragraph above, in a locating device of the kind specified above in the second paragraph above, in an audio-signal emitting system of the kind specified above in the third paragraph above, and in a method of the kind specified in the fifth paragraph above, and to provide an improved circuit, an improved locating device, an improved audio-signal emitting system, a new audio-signal receiving system and an improved method.

To achieve the object stated above, features according to the invention are provided in a circuit according to the invention, thus enabling a circuit according to the invention to be characterized in the manner stated below, namely:

A circuit for a locating device for locating a room area from which an optical locating signal generated and emitted by means of a locating-signal generating means originates, which circuit has receiving means that are arranged at a distance from the room area to be located and that are designed to receive, optically, the optical locating signal that can be fed to them from the room area, and which circuit has determining means that, by using the optical locating signal that is received, are designed to determine and emit a first item of room-area locating information that represents the distance between the receiving means and the room area.

To achieve the object stated above, features according to the invention are provided in a locating device according to the invention, thus enabling a locating device according to the invention to be characterized in the manner stated below, namely:

A locating device for locating a room area from which an optical locating signal generated and emitted by means of a locating-signal generating means originates, which locating device has a circuit as claimed in any of claims 1 to 6 and has optically operative transmitting means by means of which the optical locating signal that originates from the room area to be determined and arises in the transmitting means can be fed to the receiving means of the circuit.

To achieve the object stated above, features according to the invention are provided in an audio-signal emitting system according to the invention, thus enabling an audio-signal emitting system according to the invention to be characterized in the manner stated below, namely:

An audio-signal emitting system, which audio-signal emitting system has a circuit as claimed in any of claims 1 to 6, and which audio-signal emitting system has audio channel-signal generating means that, by taking account of at least one item of room-area locating information that can be generated by means of the circuit, are designed to generate at least two audio channel-signals suitable for creating a multi-channel sound effect, each audio channel-signal being intended for emission via sound-generating means associated with it, thus enabling a multi-channel sound effect to be created in a room area, to which room area the audio channel-signals are adjusted by taking account of the at least one item of room-area locating information.

To achieve the object stated above, features according to the invention are provided in an audio-signal receiving system according to the invention, thus enabling an audio-signal receiving system according to the invention to be characterized in the manner stated below, namely:

An audio-signal receiving system, which audio-signal receiving system has a circuit as claimed in any of claims 1 to 6, and which audio-signal receiving system has audio channel-signal receiving means that are designed to receive at least two audio channel-signals suitable for creating a multi-channel sound effect, each audio channel-signal being receivable via sound-receiving means associated with it, and that, by taking account of at least one item of room-area locating information that can be generated by means of the circuit, are designed to adjust a reception characteristic of the sound receiving means to the room area that is represented by the at least one item of room-area locating information.

To achieve the object stated above, features according to the invention are provided in a method according to the invention, thus enabling a method according to the invention to be characterized in the manner stated below, namely:

A method for locating a room area from which an optical locating signal generated and emitted by means of a locating-signal generating means originates, wherein the locating signal is received optically, with the help of receiving means, at a point that is situated at a distance from the room area to be located, and wherein, by using the optical locating signal that is received, a first item of room-area locating information that represents a distance between the receiving means and the room area is determined and emitted.

By the making of the provisions according to the invention, the advantage is obtained both with a circuit, and with a locating device, and with an audio-signal emitting system, and with an audio-signal receiving system and with a method, all according to the invention, that the room area from which the locating signal originates can be classified in respect of the range at which it lies from the receiving means of the circuit. This is of advantage particularly when what is to be created with the help of the audio-signal emitting system is a multi-channel sound effect, for which a determination of a direction from which the locating signal originates that is good enough for stereo sound reproduction is not good enough to allow the desired multi-channel sound effect to be achieved. It is also of advantage when the audio channel-signals that are to be received with the help of the audio-signal receiving means are ones by means of which it is to be possible for a multi-channel sound effect to be created when they are reproduced. Furthermore, the processing of an optical locating signal affords the advantage that an acoustic locating signal that is a nuisance for a user can be dispensed with for the purpose of determining the distance between the locating-signal generating means and the receiving means of the circuit.

In the solutions according to the invention, it has also proved to be advantageous if the provisions specified, in the respective cases, in claim 2 and claim 13 are made. This gives the advantage that the room space accessible to the receiving means can be resolved or sub-divided, both by direction and by range, into room areas from which the locating signal can be received. This is of advantage particularly when it is a question of locating the room area from which the locating signal originates by using a single locating device, which locating device is arranged, in as space-saving a manner as possible, at a particular point with which there is usually visual contact from the room area from which the locating signal is emitted, and no shadowing effects, such as are caused by a user for example, need be expected.

In the solutions according to the invention, provision may for example be made for the locating-signal generating means to be formed with the help of an incandescent lamp or a laser pointer. In one solution according to the invention however, it has proved to be particularly advantageous if, in addition, the provisions specified, in the respective cases, in claim 3 and claim 14 are made. This gives the advantage that the room area from which the locating signal originates is automatically determined directly, i.e. without the user noticing, if the remote-control device is used to control the system. This gives the further advantage that room-area information from the past is not inadvertently used because a user of the system had simply forgotten, when the system was again used, to manually, i.e. consciously, activate the determination of the room area from which the locating signal originates.

In a solution according to the invention, it has further proved to be advantageous if, in addition, the features claimed, in the respective cases, in claim 4 and claim 15 are provided. This gives the advantage that the determination of the room area from which the locating signal originates takes place with relatively high accuracy and repeatability.

In a solution according to the invention, it has further proved to be advantageous if, in addition, the features claimed, in the respective cases, in claim 5 and claim 16 are provided. This gives the advantage that the whole of the room space from which the locating signal originates can be relatively precisely divided with the help of sensors, i.e. by arranging or orienting the sensors in a suitable manner and by arranging for the sensors to be suitable in respect of their directional characteristic.

In a solution according to the invention, it has further proved to be advantageous if, in addition, the provisions specified, in the respective cases, in claim 6 and claim 17 are made. This gives the advantages that, by using a sufficiently large number of sensors, the room area from which the locating signal originates can be determined without any problems and that edge zones, for which edge zones a sufficiently large number of sensors cannot be provided to allow the said room area to be located, are substantially avoided.

In an audio-signal emitting system according to the invention, it has further proved to be advantageous if, in addition, the provisions specified in claim 9 are made. This gives the advantage that, on the basis of the room-area locating information, the adjustment of the audio channel-signals to the room area that has been located can be optimized.

In an audio-signal receiving system according to the invention, it has further proved to be advantageous if, in addition, the provisions specified in claim 11 are made. This gives the advantage that, on the basis of the room-area locating information, the adjustment of the reception characteristic can be optimized.

These and other aspects of the invention are apparent from and will be elucidated with reference to the embodiments described hereinafter, though the invention is not to be considered as limited to these.

### IN THE DRAWINGS

FIG. 1 is a schematic view in the form of a block diagram of an audio-signal emitting system having a locating device in accordance with a first embodiment of the invention.

FIG. 2 shows, in a similar way to Fig.1, the locating device of FIG. 1 in detail.

FIG. 3 shows a functional relationship between the intensity of the locating signal that exists at a sensor of the locating device shown in FIG. 2, and the distance between a locating-signal generating means and the locating device.

FIG. 4 shows a second functional relationship between the intensity of the locating signal that exists at the sensor of the locating device shown in FIG. 2, and the deviation of the direction of the locating signal incident on the sensor from a main direction of reception of the sensor.

FIG. 5 shows, in a similar way to FIG. 2, a locating device in accordance with a second embodiment of the invention.

FIG. 6 shows, in a similar way to FIG. 2, a locating device in accordance with a third embodiment of the invention.

FIG. 7 shows, in the form of a detail of Fig.1, an overlap between the range zones of a plurality of adjacent reception sectors of the locating device.

FIG. 8 shows, in a similar way to FIG. 1, an audio-signal receiving system having a locating device as shown in FIG. 2.

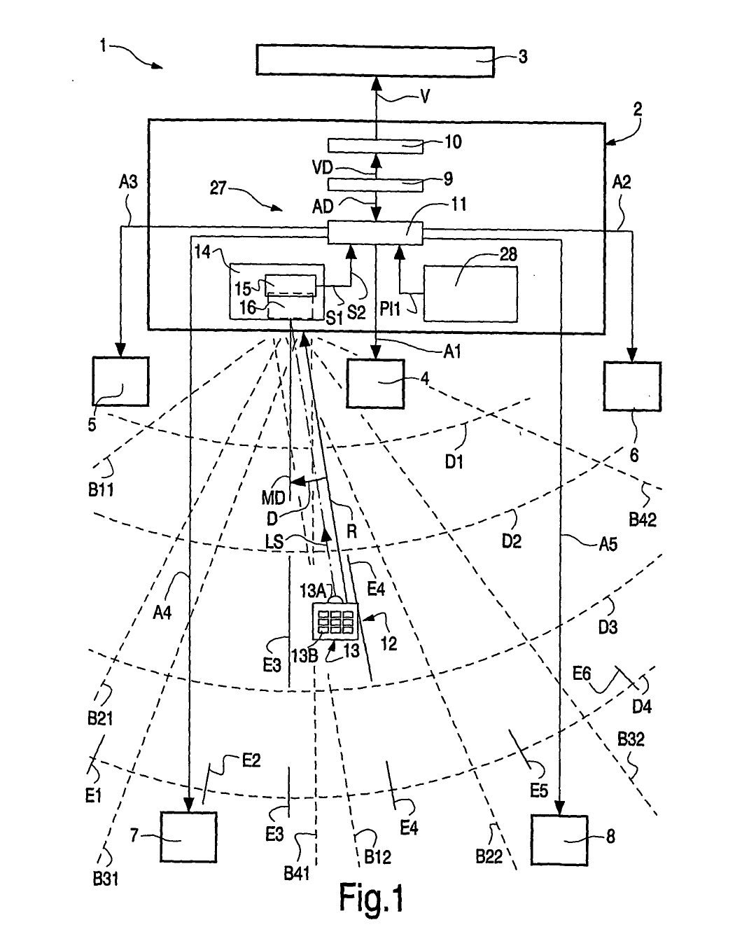

In FIG. 1 is shown a system 1, namely a so-called home cinema system that is designed for the audio-visual reproduction of a feature film recorded on a DVD. For this purpose, the system 1 has a base station 2 into which the DVD can be inserted and by which the feature film recorded on the DVD can be played back. Connected to the base station 2 is a display screen 3. Also connected to the base station 2 are sound-generating means, namely a first loudspeaker 4, a second loudspeaker 5, a third loudspeaker 6, a fourth loudspeaker 7, and a fifth loudspeaker 8. When a feature film is being played back, a video signal V can be transmitted to the display screen 3 with the help of the base station 2, which video signal V represents video information stored on the DVD. By means of the base station 2, there can also be transmitted: a first audio channel-signal A1 to the first loudspeaker 4, a second audio channel-signal A2 to the second loudspeaker 5, a third audio channel-signal A3 to the third loudspeaker 6, a fourth audio channel-signal A4 to the fourth loudspeaker 7, and a fifth audio channel-signal A5 to the fifth loudspeaker 8, the audio channel-signals A1 to A5 representing digital multi-channel audio information stored on the DVD. By means of the five audio channel-signal A1 to A5, with the audio channel-signals A1 to A5 each being intended for emission from the loudspeakers 4 to 8 respectively assigned to them, a multi-channel sound effect that is similar to the multi-channel sound that can be produced in a theater or cinema can be created for a user of the system 1 in a room area, to which room area the audio channel-signals A1 to A5 are adjusted.

For the purpose of generating the video signal V and the audio channel-signals A1 to A5, the base station 2 has a DVD drive 9 that is arranged for read access to the data stored on the DVD, which data represents the feature film. The DVD drive 9 is designed to emit video data VD and audio data AD that is included in this data, the latter representing the digital multi-channel audio information.

The base station 2 also has video-signal generating means 10 that are designed to receive the video data VD. The video-signal generating means 10 are further designed, by using the video data VD, to generate and emit the video signal V that represents the video data VD.

The base station 2 also has audio channel-signal generating means 11 that are designed to receive the audio data AD. The audio channel-signal generating means 11 are further designed to receive a first item of room-area locating information S1 and a second item of room-area locating information S2. With the help of the two items of room-area locating information S1 and S2, it is possible for the identity of a room area 12 from which a locating signal LS was transmitted to the base station 2 to be stated. The location of the room area 12 and the generation of the items of room-area locating information S1 and S2 will be looked at in detail below. By taking account of the two items of room-area locating information S1 and S2 and by using the audio data AD, the audio channel-signal generating means 11 are designed to generate and emit the five audio channel-signals A1 to A5 suitable for creating the multi-channel sound effect, thus enabling the multi-channel sound effect to be created in the room area 12 from which the locating signal LS originates, to which room area 12 the audio channel-signals A1 to A5 have been adjusted by taking account of the two items of room-area locating information S1 and S2. The audio channel-signal generating means 11 are implemented by means of a so-called multi-channel sound processor.

Shown within the room area 12 is a remote-control device 13 that can be operated by a user (who is not shown in FIG. 1). The remote-control device 13 is the form in which a locating-signal generating means, that is designed to generate and emit the optical locating signal LS, is implemented, the optical locating signal LS being formed in the present case by an optical control signal that can be generated by the remote-control device 13 and that can be transmitted to the base station 2 by the remote-control device 13 when the remote-control device 13 is operated by the user, to control functions of the base station 2.

For the purpose of generating the two items of room-area locating information S1 and S2, the base station 2 also has a locating device 14 that is designed to locate the room area 12 from which the optical locating signal LS that is generated and emitted by means of the remote-control device 13 originates. The locating device 14 has a circuit 15 and transmitting means 16.

The transmitting means 16 are designed to be optically operative so that the optical locating signal LS that originates from the room area 12 to be determined and that arises at the transmitting means 16 can be fed, by means of the latter, to the circuit 15.

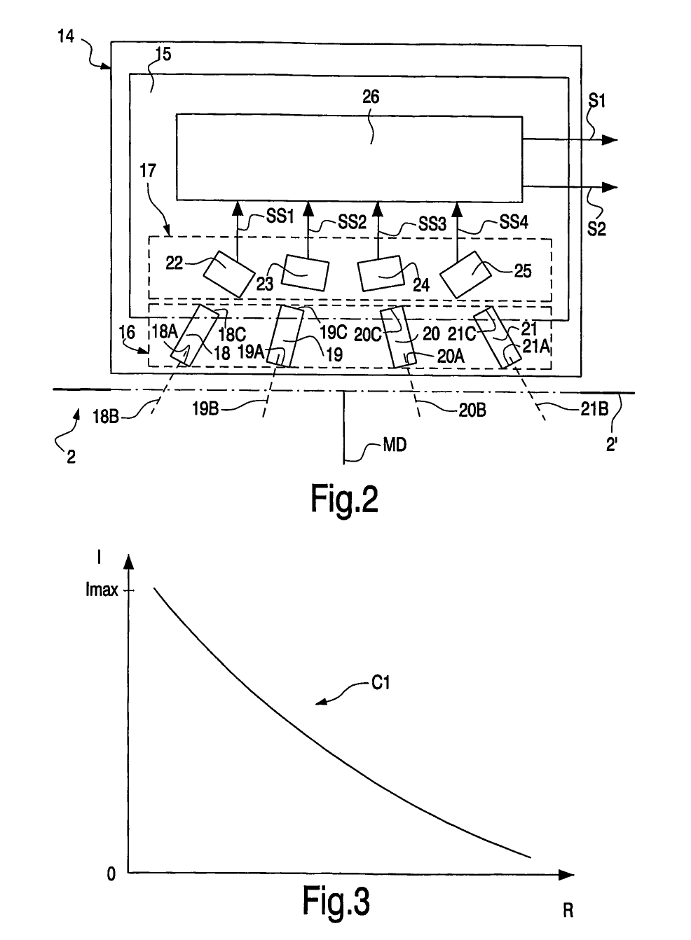

The locating device 14 is shown in detail in FIG. 2. The transmitting means 16 have a first light guide 18, a second light guide 19, a third light guide 20 and a fourth light guide 21, the four light guides 18 to 21 each being aligned in a different direction of reception. The intensity of the locating signal LS that arrives at their entry apertures 18A to 21A, which intensity can be transmitted by means of the light guides 18 to 21 to the circuit 15, is dependent on a deviation by the direction of incidence of the optical locating signal LS from the respective main directions of sensor reception 18B to 21B of the light guides 18 to 21, which directions are defined in essence by normals (perpendiculars) to the cross-sectional areas of the respective entry apertures 18A to 21A.

The circuit 15 has receiving means 17 that are arranged within the circuit 15, i.e. at a distance from the room area 12 to be located, and that are designed to receive, optically, the optical locating signal LS that can be fed to them from the room area 12. For this purpose, the receiving means 17 have four light-sensitive sensors, namely a first sensor 22, a second sensor 23, a third sensor 24 and a fourth sensor 25, which are designed and arranged to emit receive the locating signal LS and respective sensor signals SS1 to SS4. Each of the sensor signals SS1 to SS4 represents an intensity of the locating signal LS, which intensity is present at the relevant sensor 22 to 25 and, as explained above, is determined in the present case by a direction-dependent ability to couple in light that the particular light guide 18 to 21 has, and is also dependent on the range to the room area 12 from which the locating signal LS originates.

The circuit 15 also has determining means 26 that, by using the optical locating signal LS that is received—i.e. by using the sensor signals SS1 to SS4—are designed to determine and emit the first item of room-area locating information S1, that represents a distance R shown in FIG. 1 between the receiving means 17—i.e. in essence between the base station 2—and the room area 12 from which the locating signal LS originates. In addition, the determining means 26 are further designed, by using the optical locating LS signal that is received, to determine and emit the second item of room-area locating information S2, that represents a direction D between the receiving means 17—i.e. in essence between a main direction of reception MD that is defined by an overall orientation of the transmitting means 16 at the front face 2′ of the base station 2—and the room area 12 from which the locating signal LS originates. Hence the determining means 26 are designed, by using the sensor signals SS1 to SS4 that can be emitted by the sensors 22 to 25, to locate the room area 12 from which the locating signal LS originates, the room area 12 being locatable in respect of its distance R from the base station 2 and in respect of its direction D relative to the front face 2′ of the base station 2.

Due to the direction-dependent ability of the individual light guides 18 to 21 to couple in light, an individual reception sector, having its origin at the transmitting means 16, is produced for each light guide 18 to 21, in which case a locating signal LS that originates from the appropriate reception sector and is emitted towards the transmitting means 16 can be coupled into a respective one of the light guides 18 to 21. The respective reception sectors associated with the light guides 18 to 21 are shown diagrammatically in FIG. 1 by means of their sector boundaries. A first sector boundary B11 and a second sector boundary B12 define the reception sector of the first light guide 18. A third sector boundary B21 and a fourth sector boundary B22 define the reception sector of the second light guide 19. A fifth sector boundary B31 and a sixth sector boundary B32 define the reception sector of the third light guide 20. A seventh sector boundary B41 and an eighth sector boundary B42 define the reception sector of the fourth light guide 21.

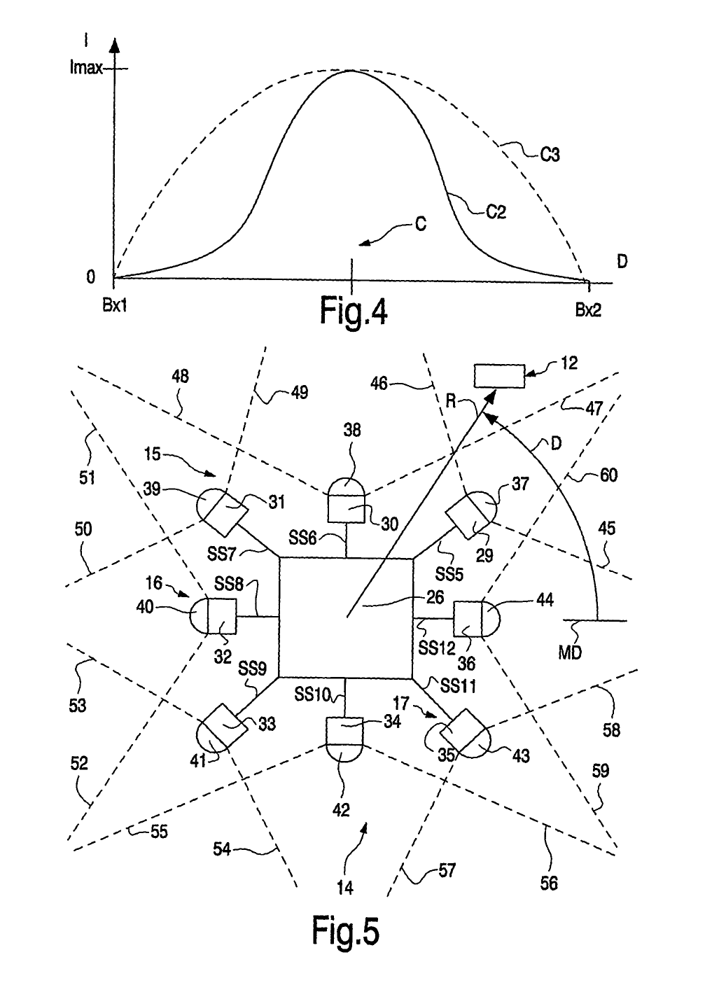

For a locating signal LS that is emitted from one of the reception sectors belonging to the light guides 18 to 21 towards the transmitting means 16, there are, for the intensity of the light that is transmitted by the respective light guides 18 to 21 to their respective sensors 22 to 25, which intensity arises at the respective sensors 22 to 25, functional relationships that are dependent on the one hand on the distance or range R at which the locating-signal generating means 13 are situated from the transmitting means 16 and on the other hand on the deviation of the direction of incidence of the optical locating signal LS from the main directions of sensor reception 18B to 21B between the sector boundaries B11 and B12, B21 and B22, B31 and B32, and B41 and B42 respectively. The respective functional relationships are shown in FIG. 3 and, in detail, in FIG. 4. In FIG. 3, the functional relationship that depends on the distance or range R along the given main direction of sensor reception 18B, 19B, 20B or 21B is shown by means of the curve C1. In this case, starting from a maximum value of intensity Imax that exists in the immediate vicinity of the transmitting means 16, there is a continuous decline in intensity as the range R increases. In FIG. 4, the functional relationship that depends on the deviation of the direction of incidence along a line transverse to the particular main direction of sensor reception 18B, 19B, 20B or 21B between the respective sector boundaries B11 and B12, B21 and B22, B31 and B32, or B41 and B42 is shown, for a random point in one of the reception sectors, by means of a curve C2. In this case, starting from the sector boundaries B11 and B12, B21 and B22, B31 and B32, and B41 and B42, there is a continuous increase in intensity until it reaches its maximum value Imax in a central region C of the reception sector, which substantially corresponds to the main direction of reception 181B, 19B, 20B or 21B of the sector. The intensity that exists at the respective 22 to 25 is therefore found by combining the two dependences given by the functional relationship, and when this is done a three-dimensional intensity-value surface similar to a mountain ridge is formed, whose maximum elevation is situated in the immediate vicinity of the transmitting means 16 and which slopes down towards a value of zero with increasing range R and/or a closer approach to the sector boundaries B11 or B12, B21 or B22, B31 or B32, or B41 or B42. The intensity I that exists in a given case is represented by the particular sensor signal SS1 to SS4. It should be mentioned at this point that the functional relationship is identical for each of the sensors 22 to 25. It is, however, also possible for different functional relationships to be selected. In an analogous way, the same is also true of the transmitting means 16 and in the present case particularly of the width of the reception sectors defined by the individual sector boundaries.

Assisted by the fact that over a relatively wide region of the room space in front of the base station 2 the reception sectors at least partly overlap with one another and at least two of the sensor signals SS1 to SS4 are thus available simultaneously, it is possible with the help of the determining means 26 for the room space in front of the base station 2 to be divided up in a relatively precise manner into range bands, as is indicated symbolically in FIG. 1 by lines of equidistance D1, D2, D3, D4, in which case each of these lines of equidistance D1 to D4 indicates a given distance from the circuit 15 or from the front face 2′ of the base station 2 and the range bands that are that can be determined, whose identity can be stated by means of the first item of room-area locating information S1, extend between the said lines of equidistance D1 to D4. It should be mentioned at this point that, for the sake of clarity, only four such lines of equidistance D1 to D4 have been shown in FIG. 1, but the actual division of the space in front of the base station 2 in terms of range can be substantially freely adapted to suit the accuracy required in the particular case.

In a similar way to the above, and assisted by the fact that over a wide region of the room space in front of the base station 2 the reception sectors at least partly overlap with one another and at least two of the sensor signals SS1 to SS4 are thus available simultaneously, it is possible with the help of the determining means 26 for the space in front of the base station 2 to be divided up in a relatively precise manner, purely by calculation, into directional regions, as is indicated symbolically in FIG. 1 by lines of equidirection E1, E2, E3, E4, E5 and E6, in which case each of these lines of equidirection E1 to E6 indicated a given direction relative to the main direction MD, and the directional areas that are that can be determined, whose identity can be stated by means of the second item of room-area locating information S2, extend between the said lines of equidirection E1 to E6. What is said in the previous paragraph with regard to the number of range bands is equally applicable to and valid for the division of the room space in front of the base station 2 in terms of direction.

Hence, with the help of the two items of room-area locating information S1 and S2, it is possible to locate those room areas which are the product of the intersection of the particular range band whose identity is given by the first item of room-area locating information Si with the particular directional area whose identity is given by the second item of room-area locating information S2.

In the present case, the sensors 22 to 25 are so designed and arranged in relation to the transmitting means 16 that each sensor 22 to 25 has associated with it a plurality of determinable room areas from which the locating signal LS can be received. This being so, there arises in the present case an overlap in terms of direction between determinable room areas that are associated with different—essentially adjacent—sectors 22 to 25. It should, however, be mentioned at this point that there may also be an overlap in terms of distance between determinable room areas if for example (as is shown in FIG. 7, which shows an area of FIG. 1 that has been reduced to the items that are essential in the present case) the division of the room space in terms of range that has been made for any reception sector differs from that made for the adjacent reception sector. This state of affairs is shown by additional lines of equidistance D1′ and D2′ and D1″ and D2″.

The sensors 22 to 25 are implemented in the form of photo-transistors, with each of the photo-transistors being so designed and arranged that its light-sensitive sensing region is oriented substantially parallel to a light exit face 18C to 21C of the light guide 18 to 21 respectively associated with it and is arranged in the immediate vicinity thereof, as a result of which any direction-dependent sensitivity to light that may possibly exist even in the case of the sensors 22 to 25 can be substantially ignored.

It should be mentioned at this point that even the sensors 22 to 25 may have a direction-dependent sensitivity to light, this direction-dependent sensitivity to light usually setting a relatively large width for the reception sectors because the said direction-dependent sensitivity to light is usually dependent on a cosine function that is shown by a curve C3 in FIG. 4. In this connection, it should also be mentioned that, by providing a lens or a lens-like housing for the sensors 22 to 25, or a housing fitted with lenses for the circuit 15, or by—as discussed above—providing light guides 18 to 21, the sensitivity to light in the reception sectors can be focused or can be concentrated on an area surrounding the central region C, as can be seen from FIG. 4 by comparing curve C2 with curve C3, thus enabling the locating-signal generating means to be located in space with sufficient exactness particularly when more than two sensors are used. It should also be mentioned that the function that is shown by means of line C1 in FIG. 3 is scaled by 1/Rˆ2, as is usual for photo-transistors, though there may be a function having a scaling different than this when sensors of other kinds are used.

In the system 1, the audio channel-signal generating means 11 and the locating device 14 form an audio-signal emitting system 27 in which the five audio channel-signals A1 to A5 can be generated by taking account of the items of room-area locating information S1 and S2 that can be generated by means of the circuit 15. The audio-signal emitting system 27 also has a first memory stage 28 that is intended to store a first item of positional information PI1 that represents a relative positioning between the circuit 15 or the base station 2 and the five loudspeakers 4 to 8. The first item of positional information PI1 can be generated at the base station 2 by a user with the help of input means that are not shown in FIG. 1. In addition to taking account of the two items of room-area locating information S1 and S2, the audio channel-signal generating means 11 are also designed to adjust the audio channel-signals A1 to A5 to the room area 12 that has been located, by using the first item of positional information PI1, thus ensuring that allowance is made for the positions at the time, or variable positions, of the loudspeakers 4 to 8.

The operation of the system 1 will now be explained below by reference to an illustrative application of the system 1 shown in FIG. 1. In this illustrative application, it will be assumed that a user is holding the remote-control device 13 in one hand in the room area 12. The user presses a start key 13B on the remote-control device 13, whereupon an optical control signal LS is emitted by the remote-control device 13, via a so-called infrared diode 13A, to control a function of the base station 2.

For the purpose of locating the room area 12, a method for locating the room area 12 from which the locating signal LS originates is performed at the base station by means of the circuit 15. The locating signal LS that is formed by the optical control signal from the remote-control device 13 is used or employed in the method. In the method, the optical control signal LS is received optically at a point that is situated at a distance from the room area 12 to be located. It actually happens at the base station 2, or rather at the locating device 14 contained in the base station 2, with the help of transmitting means 16, or to be more exact with the help of the light guides 19 and 20, by means of which the locating signal LS, or rather the proportional intensities of the locating signal LS that are coupled into the light guides 19 and 20, are transmitted to the sensors 23 and 24, because the optical control signal LS originates from the room area 12, which lies within the reception sectors of the two light guides 19 and 20. In accordance with the method, the respective proportional intensities are received by means of the two sensors 23 and 24 and sensor signals SS2 and SS3 respectively corresponding to them are generated. Each sensor signal SS2 and SS3 represents a value for the intensity of the light present at the given sensor 22 to 25, which value corresponds to the position of the remote-control device 13 between the particular sector boundaries B21 and B22, and B31 and B32, i.e. to the direction D and distance R to the transmitting means 16.

In accordance with the method, the room area 12 from which the locating signal LS originates is located with the help of the determining means 26, by using the optical control signal LS that is received, or to be exact by using the sensor signals SS1 to SS3 emitted by the sensors 22 to 25. In the course of this, the first item of room-area locating information S1 is determined and transmitted to the audio channel-signal generating means 11. In addition, the second item of room-area locating information S2 is determined and transmitted to the audio channel-signal generating means 11.

The two items of room-area locating information S1 and S2 locate the room area 12 from which the locating signal LS originates as the room area 12 that is bounded by the lines of equidirection E3 and E4 and the lines of equidistance D2 and D3. The two items of room-area locating information S1 and S2 are used in the audio channel-signal generating means 11 to adjust the audio channel-signals A1 to A5 to the room area 12 that has been located in order to create for the user the multi-channel sound effect that the latter expects or desires.

The locating device 14 shown in FIG. 5 has circumferentially arranged receiving means 17 and transmitting means 16 to enable the room area 12 from which the locating signal LS originates to be located in any desired direction around the locating device 14, and to be locatable with the help of the locating device 14, or rather the circuit 15, in respect of its range R from the locating device 14 and in respect of its direction D relative to the main direction of reception MD of the device, which is freely defined in the present case. A design of this kind for the locating device 14 is of interest when, for example, the locating device 14 is mounted on a top face of the base station 2 and the base station is located at, for example, a central point in a room and there is a high probability that the locating signal will have to be received from a direction from which the front face 2′ of the base station 2 cannot be seen. A design of this kind may, for example, also be of interest for fitting into a piece of furniture.

Eight (8) photo-transistors 29 to 36 are provided in the present case, which photo-transistors 29 to 36 form the receiving means 17. The photo-transistors are provided with respective ones of eight (8) lenses 37 to 44 so that an optimum overlap is obtained between the reception sectors belonging to adjoining photo-transistors 29 to 36. In FIG. 5, eight (8) reception sectors are defined by their respective sector boundaries, 45 and 46, 47 and 48, 49 and 50, 51 and 52, 53 and 54, 55 and 56, 57 and 58 and 59 and 60. The sensors 20 to 36 transmit respective ones of eight (8) sensor signals SS5 to SS12 to the determining means 26.

It should be mentioned that the receiving means 17 and the transmitting means 16 do not have to be aligned parallel to the top face of the base station 2 but may also be arranged at an angle thereto, thus making it easier for the locating signal LS to be received from a direction slightly above the base station 2. A locating device 4 arranged in this way is also suitable, for example, for fitting into a living-room table, in which case it must be ensured that the two items of room-area locating information S1 and S2 can be transmitted to the base station 2 in a suitable way.

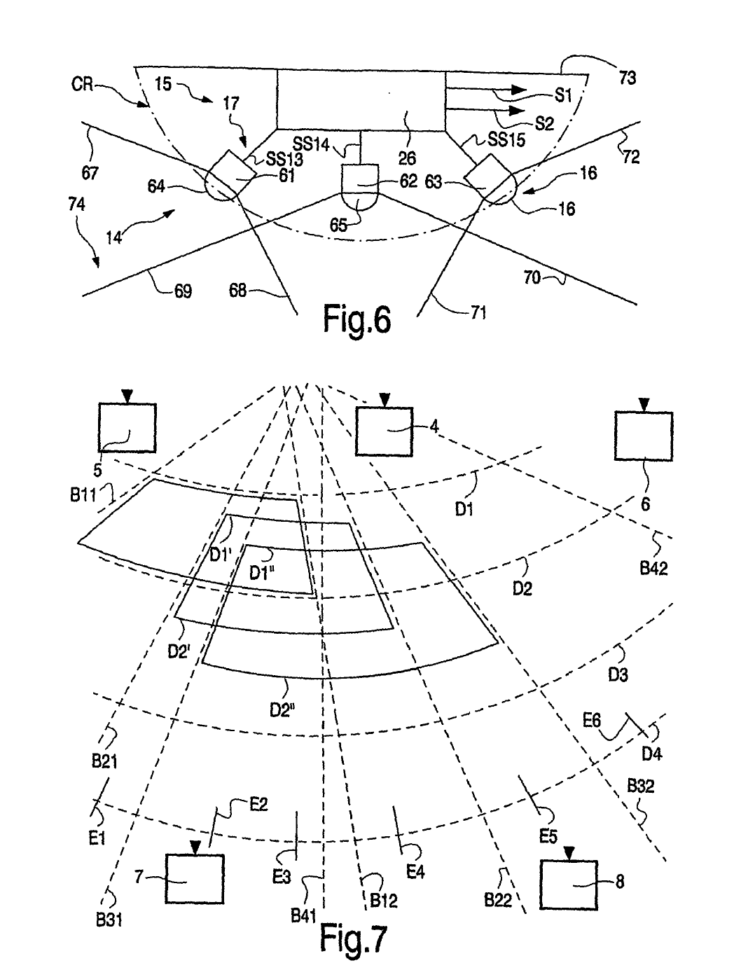

A cross-section through the locating device 14 is shown in FIG. 6. The locating device 14 has receiving means 17 arranged along the surface of a hemisphere CR. In this case too the receiving means 17 are implemented in the form of photo-transistors that are each provided with a lens. Hence the transmitting means 16, which are formed by the lenses, are also arranged along the surface of the hemisphere CR. In the present case, the reception sectors of the photo-transistors 61 to 63 that can be seen in the cross-sectional view are defined by their respective sector boundaries 67 and 68, 69 and 70 and 71 and 72. This design for the locating device 14 is of advantage when, for example, the position of the locating-signal generating means 13 is to be broken down into in the three coordinates of the room. A locating device designed in this way is, for example, suitable for fitting into a ceiling 73 of a living room 74, though in this case too it must be ensured the two items of room-area locating information S1 and S2 can be transmitted to the base station 2 in a suitable way.

For the locating device 4 shown in FIG. 5 and FIG. 6 to be used at a point where it is detached from the base station 2, it is advantageous if a representation, that can be processed by means of the audio channel-signal generating means 11, of the relative positioning between the locating device 14 and the base station 2 or between the locating device 14 and the loudspeakers 4 to 8 is stored in the first memory stage 28.

In FIG. 7 is shown an audio-signal receiving system 75 that has a receiving base station 75′ that contains the circuit 15 contained in the locating device 14. The audio-signal receiving system 75 also has audio channel-signal receiving means that are formed by five (5) microphones 76 to 80 and by an audio channel-signal processing stage 81. The microphones 76 to 80 are connected to the receiving base station 75′, i.e. to the audio channel-signal processing stage 81. The microphones 76 to 80 are arranged to receive five (5) acoustic audio channel-signals A1 to A5 and to transmit the five acoustic audio channel-signals A1 to A5 to the receiving base station 75′ in electronic form.

By taking account of the items of room-area locating information S1 and S2 that are generated by means of the circuit 15, the audio-signal receiving means are designed to adjust the reception characteristic of the audio channel-signal receiving means to the room area 12 that is represented by the items of room-area locating information Si and S2. To do 30 this, in the present case the frequency response and the amplitude of the audio channel-signals A1 to A5 that can be received in electronic form are altered with the help of the audio channel-signal processing stage 81.

However, it should be mentioned in this connection that the microphones 76 to 80 may also take the form of directional microphones and that the orientation or alignment of the directional microphones can be altered with the help of the audio channel-signal processing means 81. Provision may further be made for individual signal delays to be altered for the audio channel-signals A1 to A5 as a function of the items of room-area locating information S1 and S2.

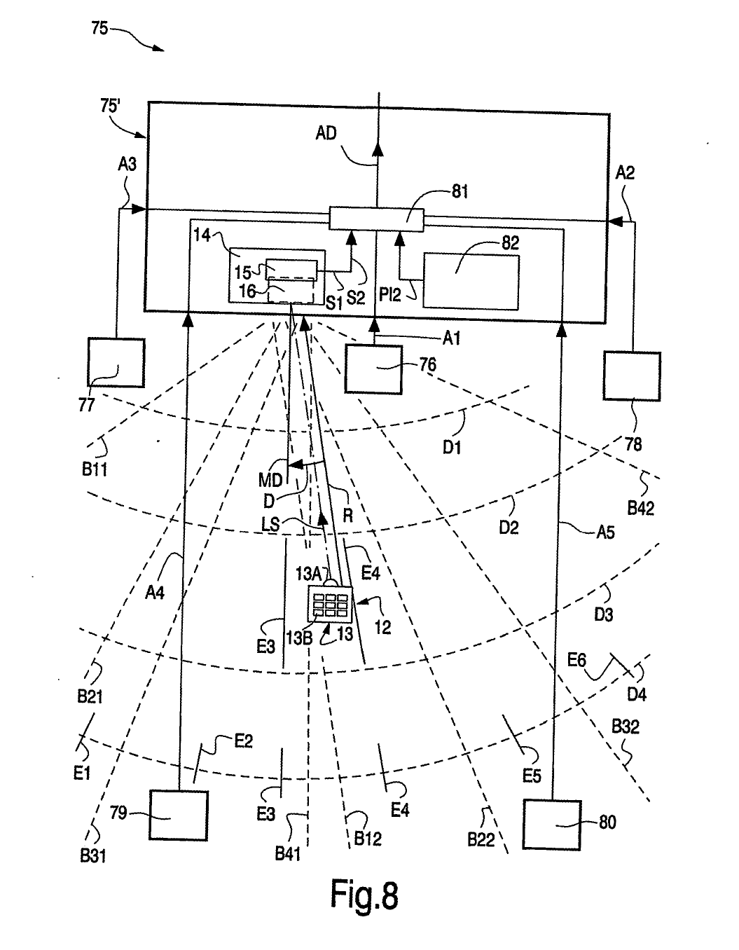

The audio-signal receiving system 75 also has a second memory stage 82 that is intended to store a second item of positional information PI2 that represents a relative positioning between the circuit 15, i.e. essentially the receiving base station 75′, and the five microphones 76 to 80. In addition, the audio channel-signal processing means 81 are designed to adjust the reception characteristic to the room area 12 that has been located, by using the items of room-area locating information S1 and S2. The second item of positional information PI2 can be entered by a user via input means that are not shown in FIG. 8.

It should be mentioned that the locating device 14 may also be implemented in the form of an integrated semiconductor module, in which case the circuit 15 is formed by an integrated circuit that has the sensors, and a housing of the semiconductor module has the transmitting means.

It should further be mentioned that the intensity of the locating signal LS present at a given sensor may also be represented by a frequency of the received signal.

It should also be mentioned that a sensor and the transmitting means associated with it may also form a structural unit.

1. A circuit (15) for a locating device (14) for locating a room area (12) from which an optical locating signal (LS) generated and emitted by means of a locating-signal generating means (13) originates, which circuit (15) has receiving means (17) that are arranged at a distance (R) from the room area (12) to be located and that are designed to receive, optically, the optical locating signal (LS) that can be fed to them from the room area (12), and which circuit (15) has determining means (26) that, by using the optical locating signal (LS) that is received, are designed to determine and emit a first item of room-area locating information (S1) that represents the distance (R) between the receiving means (26) and the room area (12).

2. A circuit (15) as claimed in claim 1, wherein the determining means (26) are in addition designed by using the optical locating signal (LS) that is received, to determine and emit a second item of room-area locating information (S2) that represents a direction (D) between the receiving means (17) and the room area (12).

3. A circuit (15) as claimed in claim 1, wherein the determining means (26) are designed to process an optical control signal that can be generated by means of a remote-control device (13) and that forms the optical locating signal (LS), and to locate the room area (12) by using the optical control signal.

4. A circuit (15) as claimed in claim 1, wherein the receiving means (17) have at least two light-sensitive sensors (22, 23, 24, 25; 29, 30, 31, 32, 33, 34, 35, 36; 61, 62, 63) that are each designed and arranged to receive the locating signal (LS) and to emit a sensor signal (SS1, SS2, SS3, SS4; SS5, SS6, SS7, SS8, SS9, SS10, SS11, SS12; SS13, SS14, SS15), the sensor signal (SS1, SS2, SS3, SS4; SS5, SS6, SS7, SS8, SS9, SS10, SS11, SS12; SS13, SS14, SS15) from each sensor (22, 23, 24, 25; 29, 30, 31, 32, 33, 34, 35, 36; 61, 62, 63) representing an intensity (I), that is present at the sensor concerned (22, 23, 24, 25; 29, 30, 31, 32, 33, 34, 35, 36; 61, 62, 63), of the locating signal (LS), and wherein the determining means (26) are designed to locate the room area (12) from which the locating signal (LS) originates by using the sensor signals (SS1, SS2, SS3, SS4; SS5, SS6, SS7, SS8, SS9, SS10, SS11, SS12; SS13, SS14, SS15) that can be emitted by the sensors (22, 23, 24, 25; 29, 30, 31, 32, 33, 34, 35, 36; 61, 62, 63).

5. A circuit (15) as claimed in claim 4, wherein the at least two light-sensitive sensors (22, 23, 24, 25; 29, 30, 31, 32, 33, 34, 35, 36; 61, 62, 63) are so designed and arranged that each sensor (22, 23, 24, 25; 29, 30, 31, 32, 33, 34, 35, 36; 61, 62, 63) has associated with it at least one reception sector from which the locating signal (LS) is that can be received.

6. A circuit (15) as claimed in claim 5, wherein the at least two light-sensitive sensors (22, 23, 24, 25; 29, 30, 31, 32, 33, 34, 35, 36; 61, 62, 63) are so designed and arranged that the reception sectors respectively associated with them at least partly overlap with one another.

7. A locating device (14) for locating a room area (12) from which an optical locating signal (LS) generated and emitted by means of a locating-signal generating means (13) originates, which locating device (14) has a circuit (15) as claimed in claim 1 and has optically operative transmitting means (16) by means of which the optical locating signal (LS) that originates from the room area (12) to be determined and arises in the transmitting means (16) can be fed to the receiving means (17) of the circuit (15).

8. An audio-signal emitting system, which audio-signal emitting system has a circuit (15) as claimed in claim 1, and which audio-signal emitting system has audio channel-signal generating means (11) that, by taking account of at least one item of room-area locating information (LS) that can be generated by means of the circuit (15), are designed to generate at least two audio channel-signals (A1, A2, A3, A4, A5) suitable for creating a multi-channel sound effect, each audio channel-signal (A1, A2, A3, A4, A5) being intended for emission via sound-generating means (4, 5, 6, 7, 8) associated with it, thus enabling a multi-channel sound effect to be created in a room area (12), to which room area (12) the audio channel-signals (A1, A2, A3. A4, A5) are adjusted by taking account of the at least one item of room-area locating information (S1, S2).

9. An audio-signal emitting system as claimed in claim 8, wherein there is provided a first memory stage (28) that is intended to store a first item of positional information (PI1) that represents a relative positioning between the circuit (15) and the respective sound generation means (4, 5, 6, 7, 8), and wherein the audio channel-signal generating means (11) are in addition designed to adjust the audio channel-signals (A1, A2, A3, A4, A5) to the room area (12) that has been located by using the first item of positional information.

10. An audio-signal receiving system (75), which audio-signal receiving system (75) has a circuit as claimed in claim 1, and which audio-signal receiving system (75) has audio channel-signal receiving means that are designed to receive at least two audio channel-signals (A1, A2, A3, A4, A5) suitable for creating a multi-channel sound effect, each audio channel-signal (A1, A2, A3, A4, A5) being receivable via sound-receiving means (76, 77, 78, 79, 80) associated with it, and that, by taking account of at least one item of room-area locating information (S1, S2) that can be generated by means of the circuit (15), are designed to adjust a reception characteristic of the sound receiving means (76, 77, 78, 79,80) to the room area (12) that is represented by the at least one item of room-area locating information (S1, S2).

11. An audio-signal receiving system (75) as claimed in claim 10, wherein there is provided a second memory stage (82) that is intended to store a second item of positional information (PI2) that represents a relative positioning between the circuit (15) and the respective sound receiving means (76, 77, 78, 79, 80), and wherein the audio channel-signal receiving means are in addition designed to adjust the reception characteristic to the room area (12) that has been located by using the at least one item of room-area locating information (S1, S2).

12. A method for locating a room area (12) from which an optical locating signal (LS) generated and emitted by means of a locating-signal generating means (13) originates, wherein the locating signal (LS) is received optically, with the help of receiving means (17), at a point that is situated at a distance (R) from the room area (12) to be located, and wherein, by using the optical locating signal (LS) that is received, a first item of room-area locating information (S1) that represents a distance (R) between the receiving means (17) and the room area (12) is determined and emitted.

13. A method as claimed in claim 12, wherein, by using the optical locating signal (LS) that is received, a second item of room-area locating information (S2) that represents a direction (D) between the receiving means (17) and the room area (12) is, in addition, determined and emitted.

14. A method as claimed in claim 12, wherein an optical control signal that can be generated by means of a remote-control devices (13) and that forms the optical locating signal (LS) is processed or used to locate the room area (12).

15. A method as claimed in claim 12, wherein the locating signal (LS) is received by means of at least two light-sensitive sensors (22, 23, 24, 25; 29, 30, 31, 32, 33, 34, 35, 36; 61, 62, 63) and a sensor signal (SS1, SS2, SS3, SS4; SS5, SS6, SS7, SS8, SS9, SS10, SS11, SS12; SS13, SS14, SS15), is generated and emitted in each case, which sensor signal (SS1, SS2, SS3, SS4; SS5, SS6, SS7, SS8, SS9, SS10, SS11, SS12; SS13, SS14, SS15) represents an intensity (I), that is present at the sensor concerned (22, 23, 24, 25; 29, 30, 31, 32, 33, 34, 35, 36; 61, 62, 63), of the locating signal (LS), and wherein the room area (12) from which the locating signal (LS) originates is located by using the sensor signals (SS1, SS2, SS3, SS4; SS5, SS6, SS7, SS8, SS9, SS10, SS11, SS12; SS13, SS14, SS15) emitted by the sensors (22, 23, 24, 25; 29, 30, 31, 32, 33, 34, 35, 36; 61, 62, 63).

16. A method as claimed in claim 15, wherein at least one sensor (22, 23, 24, 25; 29, 30, 31, 32, 33, 34, 35, 36; 61, 62, 63) receives the locating signal (LS) from at least one reception sector associated with the sensor concerned (22, 23, 24, 25; 29, 30, 31, 32, 33, 34, 35, 36; 61, 62, 63).

17. A method as claimed in claim 15, wherein the locating signal (LS) is received simultaneously from reception sectors that at least partly overlap with one another by at least one sensor (22, 23, 24, 25; 29, 30, 31, 32, 33, 34, 35, 36; 61, 62, 63), each reception sector having one sensor (22, 23, 24, 25; 29, 30, 31, 32, 33, 34, 35, 36; 61, 62, 63) associated with it.
